(19) United States
(12) Patent Application Publication
(10) Pub. No.: US 2026/0155887 A1
(43) Pub. Date: Jun. 4, 2026

(54) FIBER TERMINAL OPTICAL SIGNATURE RESPONDER

(71) Applicant: AT&T Intellectual Property I, L.P., Atlanta, GA (US)

(72) Inventors: Ricky A. Perry, Cumming, GA (US); Gregory D. Olson, Plano, TX (US)

(73) Assignee: AT&T Intellectual Property I, L.P., Atlanta, GA (US)

(21) Appl. No.: 18/968,199

(22) Filed: Dec. 4, 2024

(51) Int. Cl. H04B 10/07

(52) U.S. Cl. CPC H04B 10/07

(57) ABSTRACT

Aspects of the subject disclosure may include, for example, associating a first optical signature including a first distinct wavelength profile of a group of wavelength profiles, with a first optical signature responder deployed at a first location, wherein the first optical signature responder is coupled to a distal end of an optical fiber and wherein the first optical signature responder is configured to selectively reflect only the first distinct optical wavelength profile. A test signal is injected into a proximal end of the fiber and an optical spectrum including the group of wavelength profiles is monitored at the proximal end to obtain a response signal. An absence of the first distinct wavelength profile within the response signal indicates fault condition associated with the first optical signature responder. Other embodiments are disclosed.

### FIELD OF THE DISCLOSURE

The subject disclosure relates to a fiber terminal optical signature responder.

### BACKGROUND

In optical fiber telecommunications, data signals are converted into light signals, e.g., pulses, that travel through optical fiber cables. A “fiber plant” refers to an entire infrastructure of installed optical fiber cables used to transmit data, including the cables themselves, connectors, splices, and/or supporting hardware. The fiber plant essentially encompasses a physical network built with optical fiber technology, referring to the complete system for transmitting signals using light through optical fiber cables. The fiber plant refers to permanently installed optical fiber equipment between two end points of a communications link.

When referring to a fiber plant in the context of telecommunications, outside plant (OSP) is often used to denote the part of the network that is outside of buildings, like cables running underground or on utility poles. Generally, optical fiber cables and supporting equipment may be configured according one or more of subterranean configurations, in which cables and supporting equipment may be buried underground, aerial configurations, in which cables and supporting equipment may be supported above ground, e.g., on supporting poles, and/or submarine applications in which cables and/or supporting equipment may be installed underwater.

In a fiber to the home (FTTH) configuration, the fiber plant provides an optical fiber communications link between an optical line terminal (OLT) central location, sometimes referred to as a central office (CO) or headend and an optical network terminal (ONT) at a consumer location, e.g., a home or business, sometimes referred to as premises. The fiber plant may include a feeder cable extending between a CO and some downstream distribution location at which an optical signal splitter or divider divides a downstream optical signal from the CO into some larger number of optical signals that can feed multiple downstream optical fibers according to a power splitting ratio, e.g., a 1×N splitter. The downstream optical fibers can be referred to as a distribution cable, in which the individual optical fibers are configured to serve respective customer premises, e.g., with an individual optical fiber dedicated to each of the premises.

During what is referred to as a construction phase, the optical fiber plant can be installed and situated to serve existing subscribers and/or to be available proximately to subscriber locations in anticipation of subsequent subscriptions. Consider an example in which outside plant optical fibers are deployed to a neighborhood, e.g., with a single fiber being provisioned for each home. The distribution cable may include taps at which a subgroup of cables is routed to a flexible service terminal (FST). The FST generally provides a small, compact terminal unit configured to distribute fiber optic connections to individual customer premises, particularly in Fiber-To-The-Home (FTTH) networks. The FST may feature a flexible structure with pre-terminated hardened connectors that allow for easy installation in tight spaces and harsh outdoor environments. Essentially, the FST is a plug-and-play device with multiple output cables of varying lengths to reach different service points from a single incoming fiber line, all while being robust enough for outside plant applications. Connections to customer premises may be completed by a connectorized cable between the FST and an ONT at the customer premises.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications system in accordance with various aspects described herein.

FIG. 2A is a block diagram illustrating an example, non-limiting embodiment of an optical fiber distribution system functioning within the communications system of FIG. 1 in accordance with various aspects described herein.

FIG. 2B is a block diagram illustrating an example, non-limiting embodiment of an optical signature responder functioning within the optical fiber distribution system of FIG. 2A and the communications system of FIG. 1 in accordance with various aspects described herein.

FIG. 2C is a block diagram illustrating another example, non-limiting embodiment of an optical signature responder functioning within the optical fiber distribution system of FIG. 2A and the communications system of FIG. 1 in accordance with various aspects described herein.

FIG. 2D is a block diagram illustrating another example, non-limiting embodiment of an optical signature responder functioning within the optical fiber distribution system of FIG. 2A and the communications system of FIG. 1 in accordance with various aspects described herein.

FIG. 2E is a block diagram illustrating yet another example, non-limiting embodiment of an optical signature responder functioning within the optical fiber distribution system of FIG. 2A and the communications system of FIG. 1 in accordance with various aspects described herein.

FIG. 2F is a block diagram illustrating another example, non-limiting embodiment of an optical fiber distribution system functioning within the communications system of FIG. 1 in accordance with various aspects described herein.

FIG. 2G is a graph illustrating example optical test signals, obtained from a non-limiting embodiment of an optical signature responder functioning within the optical fiber distribution system of FIG. 2F and the communications system of FIG. 1 in accordance with various aspects described herein.

FIG. 2H is another graph illustrating example optical test signals, obtained from a non-limiting embodiment of an optical signature responder functioning within the optical fiber distribution system of FIG. 2F and the communications system of FIG. 1 in accordance with various aspects described herein.

FIG. 2I depicts an illustrative embodiment of an optical fiber terminal failure detection process in accordance with various aspects described herein.

FIG. 3 is a block diagram illustrating an example, non-limiting embodiment of a virtualized communications network in accordance with various aspects described herein.

FIG. 4 is a block diagram of an example, non-limiting embodiment of a computing environment in accordance with various aspects described herein.

### DETAILED DESCRIPTION

The subject disclosure describes, among other things, illustrative embodiments for associating an optical signature with responder deployed at a predetermined location and configured to reflect a signature spectral portion of an optical test signal corresponding to the optical signature, while rejecting other portions of the test signal, such that an absence of the signature spectral portion within a response signal indicates a fault condition associated with the responder and at the predetermined location. Other embodiments are described in the subject disclosure.

One or more aspects of the subject disclosure include a device that includes an optical port configured to receive an optical test signal including a first wavelength component and a second wavelength component. The device also includes housing in communications with the optical port, wherein the optical port is adapted to receive the optical test signal from an optical fiber and to direct the optical test signal along an optical path towards an interior region of the housing. The interior region of the housing includes a reflector positioned along the optical path and adapted to reflect at least a portion of the optical test signal to obtain a reflected optical signal. The interior region also includes an optical waveguide defining at least a portion of the optical path, wherein the optical waveguide is optically coupled between the optical port and the reflector, and an optical filter positioned along the optical path. The optical filter is configured to pass the first wavelength component and to reject the second wavelength component. The device is configured to provide an optical response signal, including the reflected optical signal having the first wavelength component without the second wavelength component, directed toward the optical fiber via the optical port. The optical response signal is indicative of an interconnection of the device to a fiber plant.

One or more aspects of the subject disclosure include a process that includes associating, by a processing system including a processor, a first optical signature with a first optical distribution terminal deployed at a first predetermined location of a group of optical distribution terminals deployed at a group of predetermined locations. The first optical signature has a first distinct optical wavelength profile of a group of distinct optical wavelength profiles. The first optical distribution terminal is optically coupled to a distal end of an optical fiber cable, wherein the first optical distribution terminal is configured to selectively reflect only the first distinct optical wavelength profile of the group of distinct optical wavelength profiles. According to the process, an optical test signal is generated, by the processing system, including the plurality of distinct optical wavelength profiles. The optical test signal is injected, by the processing system, into a proximal end of the optical fiber cable to obtain a transmitted optical test signal directed toward the group of optical distribution terminals. Further according to the process, an optical spectrum of an optical response signal is measured, by the processing system and at the proximal end of the optical fiber cable, to obtain a measurement result. The optical spectrum of the optical response signal includes the group of distinct optical wavelength profiles. An absence of the first distinct optical wavelength profile is detected, by the processing system, within the measurement result and responsive to the absence of the first distinct optical wavelength profile, a fault condition is identified, by the processing system, associated with the first optical distribution terminal.

One or more aspects of the subject disclosure include a non-transitory machine-readable medium, comprising executable instructions that, when executed by a processing system including a processor, facilitate performance of operations, the operations comprising: associating a first optical signature comprising a first distinct optical wavelength profile of a plurality of distinct optical wavelength profiles, with a first optical signature responder deployed at a first predetermined location of a plurality of optical signature responders deployed at a plurality of predetermined locations, wherein the first optical signature responder is optically coupled to a distal end of an optical fiber cable, wherein the first optical signature responder is configured to selectively reflect only the first distinct optical wavelength profile of the plurality of distinct optical wavelength profiles; injecting an optical test signal comprising the plurality of distinct optical wavelength profiles into a proximal end of the optical fiber cable to obtain a transmitted optical test signal directed toward the plurality of optical signature responders; monitoring, at the proximal end of the optical fiber cable, an optical spectrum of an optical response signal to obtain a monitored optical spectrum, wherein the monitored optical spectrum comprises the plurality of distinct optical wavelength profiles, and wherein the optical response signal comprises portions of the optical test signal reflected by the plurality of optical signature responders; detecting an absence of the first distinct optical wavelength profile within the monitored optical spectrum; and identifying, responsive to the absence of the first distinct optical wavelength profile, a fault condition associated with the first optical signature responder.

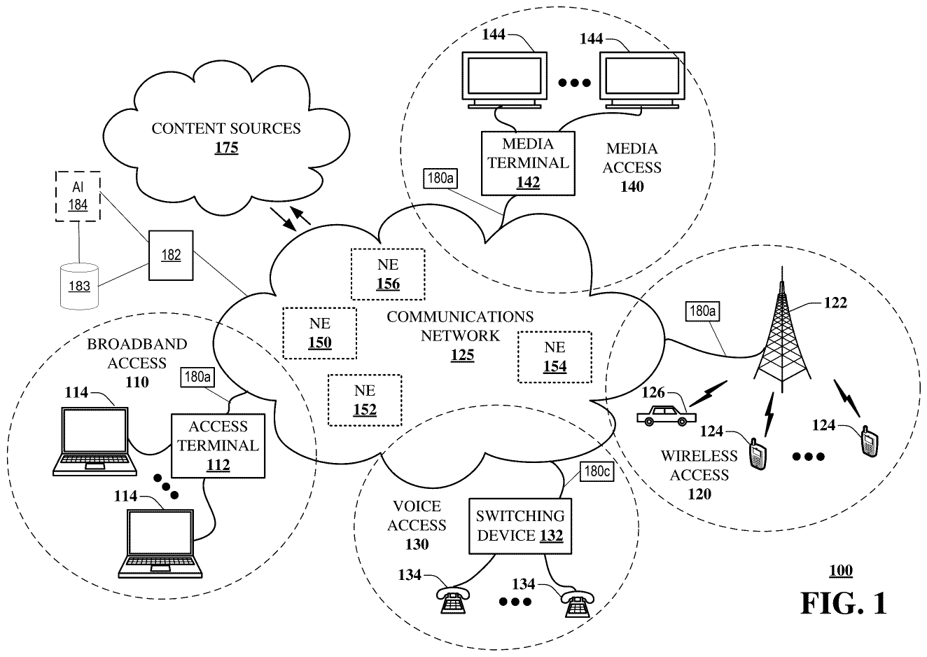

Referring now to FIG. 1, a block diagram is shown illustrating an example, non-limiting embodiment of a system 100 in accordance with various aspects described herein. For example, the communications system 100 can facilitate in whole or in part associating an optical signature with an optical signature responder deployed at a predetermined location and configured to reflect a signature spectral portion of an optical test signal corresponding to the optical signature, while rejecting other portions of the test signal. An absence of the signature spectral portion within a response signal indicates a fault condition associated with the responder and at the predetermined location. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc., for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc., can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

The example communications system 100 includes one or more optical signature responders 180a, 180b, 180c, 180d, generally 180, deployed in respective optical fiber distribution systems and configured to filter a common downstream optical test signal according to a respective distinct optical wavelength profile and to return a filtered, upstream optical response signal. A fault detection system 182 is provided in communication with the optical signature responders 180, e.g., via the communications network 125. The fault detection system 182 can include an optical signal source configured to generate an optical test signal comprising a group of distinctive optical wavelength profiles. The fault detection system 182 can include an optical detector configured to detect and/or otherwise monitor an optical reply signal as may be returned by the optical signature responders 180. The fault detection system 182 may be configured to access a predetermined association of the optical signature responders 180 with their respective deployed locations, e.g., a record of the association as may be retained in a fault detection storage system 183. The fault detection system 182 may be configured to identify situations in which one or more of the distinctive optical wavelength profiles of the optical test signal fail to be observed in the optical response signal, and to further identify locations of any corresponding optical signature responders 180. The identified locations can be reported, e.g., according to an alarm and/or a status report, such that investigative and/or corrective action may be undertaken to remedy any deficiencies as may exist in the communications system 100.

In at least some embodiments, the communications system 100 may include an artificial intelligence (AI) and/or machine learning (ML) system 184. The AI/ML system 184 can be configured to generate, monitor and/or otherwise evaluate performance of the fault detection system 182 and/or the optical signature responders 180. In some examples, the AI/ML system 184 can employ deep learning to generate and/or otherwise train a generative AI model configured to identify failure conditions via the optical signature responders 180. In at least some embodiments, the AI/ML system 184 can be trained to further identify locations and/or corresponding fault conditions likely to result in observed system degradation.

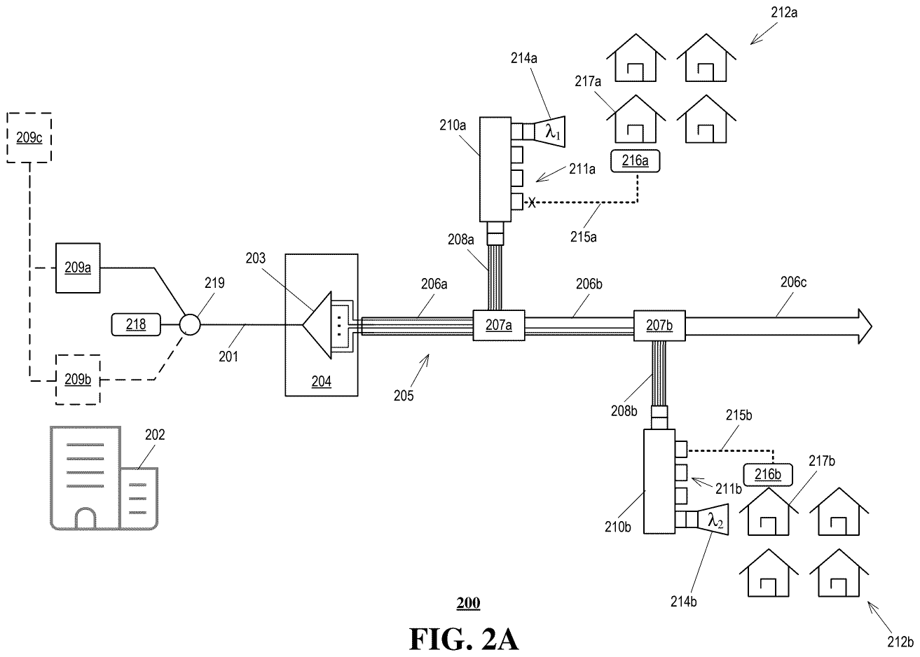

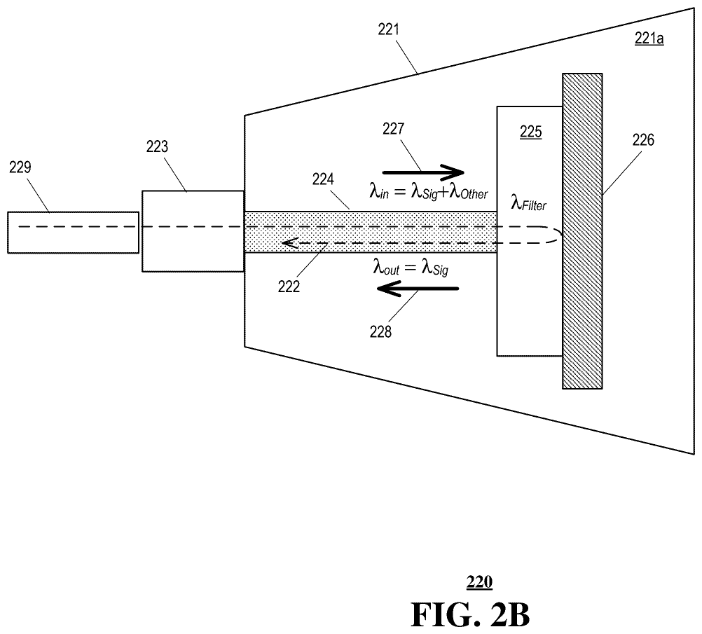

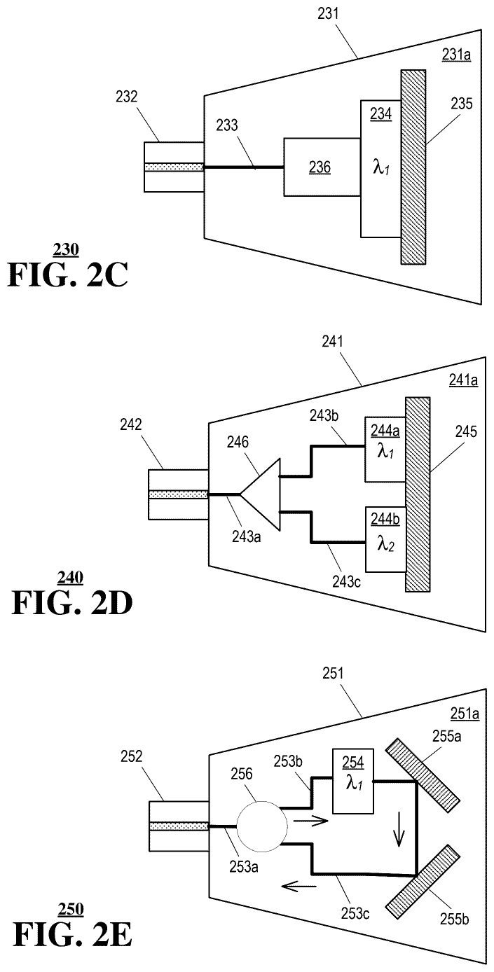

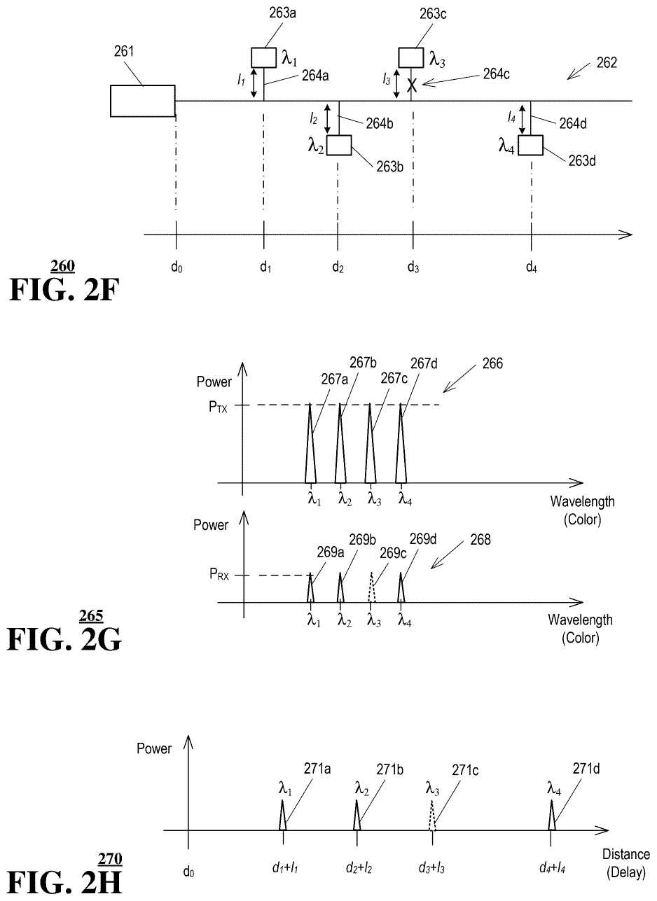

FIG. 2A is a block diagram illustrating an example, non-limiting embodiment of an optical fiber distribution system 200 functioning within the communications system 100 of FIG. 1 in accordance with various aspects described herein. The optical fiber distribution system 200 includes a headend or signal distribution source as may be provided at a centralized location, e.g., at a central office (CO) 202. The optical fiber distribution system 200 optical fiber components referred to generally as a fiber plant, or a physical fiber plant. These components can include, without limitation optical fiber cables, splices, connectors, optical signal splitters and/or combiners, optical taps, fiber repeaters optical line terminals, optical network terminals, amplifiers, equipment cabinets, trenches, supporting facility poles, and so on. At least a portion of the physical fiber plant components are passive, at least in that they perform their intended function without requiring electrical inputs. In at least some embodiments, substantial segments of the physical fiber plant may include such passive optical devices, referred to generally as a passive optical network (PON). It is envisioned that optical fiber cables of a PON may be arranged according to a centralized trunk in communication with one or branches extending away from the centralized trunk. The branches may be further subdivided into subbranches and so on. In at least some embodiments, a branch may terminate in an optical terminal device, such as a fiber serving terminal. The fiber serving terminal may include a relatively limited number of optical ports, e.g., 4, 6, 8 or 12 optical-fiber connectors, configured to serve a corresponding number of customer premises via relatively short optical fiber runs, referred to as cable drops, e.g., from the fiber serving terminal to a demarcation point at the customer premises, e.g., to an optical network terminal at a home, apartment or business.

According to the illustrative example, an optical fiber feeder cable 201 extends from the CO 202, e.g., from an optical line terminal (OLT) 218 at the CO 202 to a first optical signal splitter 203. The example optical signal splitter provides a 1×N division of a downstream optical cable to N extension cables. It is understood that in at least some embodiments, the optical fiber feeder cable 201 may include one or more individual optical fibers that, at least some instances, may be subjected to optical signal division, e.g., by the first optical sigla splitter 203. Optical division rations may include, without limitation, 1×2, 1×4, 1×8, 1×16, 1×32, 1×64, 1×128 and so on. According to the illustrative example, the optical signal splitter 203 may be housed in a physical fiber plant cabinet, e.g., an environmental enclosure at some location distant from the CO 202. An output of the optical signal splitter 203 feeds an upstream end of a first segment 206a of an optical-fiber trunk or optical-fiber distribution cable 205, e.g., having 144 individual optical fibers.

The first segment 206a of the optical-fiber distribution cable 205 extends to a first location at which a first splice 207a is introduced. The first splice 207a separates a first subgroup of the individual fibers of the optical-fiber distribution cable 205, directed towards a first branch of the optical fiber distribution system 200. In at least some embodiments, the first splice 207a includes a first tethered segment 208a containing the first subgroup of the individual fibers extending for some length and terminated in fiber couplers, e.g., optical-fiber splices and/or optical-fiber connectors. Other splices may be introduced further downstream. For example, the optical-fiber distribution cable 205 includes a second segment 206b extending to a second location at which a second splice 207b is introduced. The optical-fiber distribution cable 205 may include one or more further downstream segments and/or splices, such as the example third segment 206c.

It is common during a construction phase to deploy the optical-fiber distribution cable 205 and one or more branches to extend to some locations of existing subscribers as well as other locations in anticipation of future subscribers. Even when serving existing subscribers, it is envisioned that expansion capacity, e.g., in terms of optical fibers, may be routed to proximities of likely subscribers. In particular, the individual optical fibers may be routed to various locations in such a manner that connections to subscribers may be accomplished with relatively short individual cable runs. Such capacity planning may result in a particular configuration of the optical fiber distribution system 200, e.g., as in a number and/or location of branches requiring splices 207a, 207b, generally 207, numbers of fibers allocated to the branches, and so on.

According to the illustrative example, the first tethered segment 208a of the first branch extends to a first fiber serving terminal 210a positioned proximally to a first group of actual and/or anticipated subscriber premises 212a. A second tethered segment 208b of the second branch extends to a second fiber serving terminal 210b positioned proximally to a second group of actual and/or anticipated subscriber premises 212b. The fiber serving terminal 210a can include a first number of optical ports 211a that may be terminated in an optical coupler, e.g., a splice and/or an optical-fiber connector. The first fiber serving terminal 210a may be mounted on a utility pole and/or in an equipment enclosure or cabinet, which may include a buried enclosure located within some relatively short distance to the first group of premises 212a. In at least some embodiments, the number of optical ports 211a may also correspond to the number of premises of the first group of premises 212a, such that the physical fiber plant can accommodate up to all premises, or some percentage, of the first group of premises 212a. Without limitation, the fiber serving terminal 210a may include 4, 6, 8 or 12 optical ports 211a, e.g., with each port serviced by a respective individual optical fiber. When a customer subscribes for service, a relatively short optical fiber run, or optical-fiber cable drop is coupled between a respective one of the optical ports 211a and a demarcation point, e.g., an ONT 216a of the customer's premises 217a.

It is understood that functionality of the optical fiber distribution system 200 may be tested to ensure operability during installation, expansion, reconfiguration and/or according to routine maintenance. Testing may include optical signal loss and/or continuity testing, e.g., from the headend at the CO 202 to one or more downstream locations, such as to the fiber serving terminals 210a, 210b, generally 210. It is also understood that in at least some buildouts, a fiber serving terminal 210 may not yet have any subscribers. In this sense, the corresponding optical fibers coupled to the optical ports 211a, 211b, generally 211, may not be activated with an optical signal, e.g., they may be left dark until such time as a subscriber request service.

It is envisioned that in at least some situations, an optical link that may have passed an acceptance test during construction, may have subsequently succumbed to some hazard that may have rendered the optical link inoperable. Such hazards may include construction activity, weather related activity, animal hazards, e.g., squirrels and/or gophers, and the like. In such instances, the problem may not be discovered until a first customer of the corresponding group of customer premises 217a, 217b, generally 217, request service. In such instances, the problem may be discovered during installation of the cable drop 215a, 215b, generally 215. However, the problem may be located at the fiber serving terminal 210, or perhaps at any upstream location between the fiber serving terminal 210 and the headend at the CO 202. Resolution of the issue may require substantial investigation and/or repair, very likely far more than an installation crew would be capable of performing during installation of the cable drop 215. Any resolution and/or resulting delay could be costly in terms of investigation, repair, and quite possibly loss of subscribers.

The devices, systems, processes and/or software techniques disclosed herein, allow a network operator to monitor a status of the optical fiber distribution system 200, including so-called “dark” fibers that yet may not have been activated in support of a subscriber. To this end, the optical fiber distribution system 200 includes one or more optical signature responders 214a, 214b, generally 214. The optical signature responders can be configured to return an optical signal in response a downstream optical test signal in such a manner as to allow the returned signal to be associated with a particular optical fiber and/or branch and/or other segment of the optical fiber distribution system 200 as may be convenient to identify and/or otherwise locate issues.

By way of example, a first optical signature responder 214a can be configured to return a first optical signal corresponding to a first distinct optical wavelength profile λ₁. The first distinct optical wavelength profile may include a first single wavelength and/or first relatively narrow wavelength band, e.g., around a first center wavelength. Likewise, a second optical signature responder 214b can be configured to return a second optical signal corresponding to a second distinct optical wavelength profile λ₂. The second distinct optical wavelength profile may include a second single wavelength and/or second relatively narrow wavelength band, e.g., around a second center wavelength. It is understood that the first and second optical wavelength profiles are distinct in that they can be identified and/or otherwise differentiated by test measurement equipment.

By way of example, an optical test source 209a is configured to generate an optical test signal. The optical test signal can be configured include multiple distinct optical wavelength profiles, including those distinct optical wavelength profiles associated with the optical signature responders 214a, 214b, generally 214. In some embodiments, the optical test source 209a is configured to transmit multiple optical wavelength profiles simultaneously, e.g., according to a broad-spectrum optical test signal. Alternatively, or in addition, the optical test source 209a is configured to transmit multiple optical wavelength profiles sequentially, e.g., each optical wavelength profile separated from another by some time delay.

The optical signature responders 214 can be deployed at various locations within the optical fiber distribution system 200. For example, at least one optical signature responder 214 can be coupled to a respective optical port of an available group of optical ports 211a, 211b, generally 211, of a fiber serving terminal 210. The optical signature responders 214 may be distinguished by a label or some other indication corresponding to a respectively distinct optical wavelength profile. A record of an association of the optical signature responders 214 and/or their respectively distinct optical wavelength profiles, to their installation and/or deployment locations, may be generated.

In at least some embodiments, the optical test source 209a injects an optical test signal into an upstream location, such as at the headend, e.g., at the CO 202. For example, the optical test source 209a may be coupled to a headend of the optical fiber feeder fiber 201 via an optical coupling device 219. Without limitation, the optical coupling device 219 can include an optical signal splitter and/or combiner, e.g., a splitter/combiner, an optical fiber splice, an optical switch, e.g., an optical fiber switch, an optical circulator, e.g., an optical fiber circulator, an optical fiber tap, and the like. The optical test signal includes at least those optical wavelength profiles associated with any deployed optical signature responders 214. In the absence of any defects, each optical signature responder 214 can be configured to return a respective upstream response signal according to a distinct optical wavelength portion associated with the particular optical signature responder 214. All deployed optical signature responders 214 can be configured to respond in a like manner according to their respectively distinct optical wavelength portions.

The optical test source can include an optical source capable of generating one or more optical signals that include at least those respectively distinct optical wavelength portions associated with the deployed optical signature responders 214. For example, the optical test source 209a may include a semiconductor device. In at least some embodiments, the optical test source may include an incoherent or broadband light source, such as a light emitting diode (LED), a lamp, a flash lamp, the sun. Alternatively, or in addition, the optical test source 209a includes a coherent source, e.g., a laser. Lasers can include, without limitation, vertical-cavity surface-emitting lasers (VCELs), Fabry-Perot (FP) lasers, and/or distributed feedback (DFB) lasers. Coherent sources can include, without limitation, a laser, such as a semiconductor laser diode and/or a laser diode array.

The example optical fiber distribution system 200 includes an optical reply signal monitoring device, e.g., an optical detector 209b. The optical detector 209b may be configured in such a manner so as to receive any reply signal returned by the deployed optical signature responders 214. For example, the optical detector 209b may be coupled to a headend of the optical fiber feeder fiber 201 via an optical coupling device. In at least some embodiments, the optical coupling device may be the same optical coupling device 219 used by the optical test source 209a. In at least some embodiments, the optical detector 209b includes a semiconductor device configured to convert received optical signal into a corresponding electrical signal. Example optical detectors 209b include, without limitation photodiodes.

In at least some embodiments, the example optical fiber distribution system 200 includes a fault detection controller 209c. The fault detection controller 209c may be in communication with one or more of the optical test source 209a and/or the optical detector 209b. In operation, the fault detection controller 209c may be configured to operate one or more of the optical test source 209a and/or the optical detector 209b. For example, the fault detection controller 209c may configured to provide a control signal configured to initiate the optical test signal, e.g., by controlling the optical test source 209a to generate the optical test signal, which is injected into the headend of the optical fiber feeder cable 201. In at least some embodiments, the control signal may include a simple command to initiate a pre-programmed optical test signal. Alternatively, or in addition, the control signal may provide further detail, including one or more of a wavelength tuning instruction and/or a timing instruction, such that execution of the instructions results in generation of the optical test signal including one or more of the distinct optical wavelength profiles.

In at least some embodiments, the fault detection controller 209c can be configured, e.g., programmed and/or adjusted via selections received via a user interface, to initiate one or more optical test signals according to a test schedule. The schedule may include regularly scheduled intervals, e.g., hourly, daily, weekly, monthly, seasonally, yearly and so on. Alternatively, or in addition, the fault detection controller 209c can be configured to initiate one or more optical test signals according to an event, such as receipt of a request for service, reporting of a service issue, deployment of a technician and/or service crew and so on.

In at least some embodiments, the optical detector 209b is configured to distinguish the distinct optical wavelength profile λ₁, λ₂ among the optical reply signal. For example, in some embodiments, the optical detector 209b is configured to distinguish the distinct wavelength profiles according to a frequency domain, e.g., distinguishing λ₁ from λ₂. Alternatively, or in addition, the optical detector 209b is configured to distinguish the distinct wavelength profiles in a time domain, e.g., according to a time interval corresponding to a time at which an optical test signal was injected by the optical test source 209a.

In at least some embodiments, the optical test source 209a is in communication with the optical detector 209b. For example, the optical test source 209a can provide a notification signal indicating that the optical detector 209b has injected a test signal, such that a response signal should be expected. In at least some embodiments the notification signal can include further details, such as a time at which the optical test signal was injected and/or a distinct wavelength profile and/or group of profiles included in the optical test signal. Alternatively, or in addition, the optical detector 209b may be configured to receive such notifications from the fault detection controller 209c.

It is envisioned that in at least some embodiments, one or more of the optical test source 209a, the optical detector 209b and/or the fault detection controller 209c acquires a record and/or report of the deployed optical signature responders 214. The record and/or report may include one or more of an association of the distinct optical wavelength profiles with the optical signature responders 214 and/or a location of the deployed optical signature responders 214. In at least some embodiments, one or more of the optical test source 209a, the optical detector 209b and/or the fault detection controller 209c acquires a record and/or report of prior test results, e.g., including delay values between signal injection of the optical test signal and receipt of a reply or return signal, amplitudes, maintenance activity, and so on.

In at least some embodiments, one or more of the optical test source 209a, the optical detector 209b and/or the fault detection controller 209c can be configured to process information obtained from one or more of the optical test source 209a, the optical detector 209b and/or the fault detection controller 209c, to determine a status of the optical fiber distribution system 200. For example, the status may identify a deficiency in an expected reply signal corresponding to one or more of the distinct optical wavelength portions. Deficiencies may include, without limitation, a complete lack of any response, a response having an amplitude, e.g., an optical power, that is substantially lower than expected and/or previously measured, and/or some other indication of signal delay and/or interference.

FIG. 2B is a block diagram illustrating an example, non-limiting embodiment of an optical signature responder 220 functioning within the optical fiber distribution system 200 of FIG. 2A and the communications system 100 of FIG. 1 in accordance with various aspects described herein. The example optical signature responder 220 includes an optical port 223 configured to receive an optical test signal 227, such as the previously described downstream optical test signal including a first distinct optical wavelength component and a second distinct optical wavelength component. The example optical signature responder 220 further includes a housing 221, such as an environmental housing defining an interior region 221a. The housing 221 is sized and otherwise configured to encapsulate and/or protect components contained therein from environmental conditions. The housing 221 is in communication with the optical port 223, which is adapted to receive the optical test signal 227 from an optical fiber and to direct the optical test signal 227 along an optical path 222 towards the interior region 221a of the housing.

According to the illustrative example, the housing 221 includes a reflector 226 positioned along the optical path 222 and adapted to reflect at least a portion of the optical test signal 227 to obtain a reflected optical signal. Without limitation, the reflector 226 can include a planar structure, such as a planar mirror, e.g., a first surface mirror in which a reflective surface is supported on a substrate, with the reflective surface being in contact with the optical path 222. Alternatively, or in addition, the reflector 226 can include a non-planar structure, such as a prism, and/or other curved surface, e.g., a concave reflector, as may be well suited for reflecting a substantial portion of an optical signal impingent thereon.

In at least some embodiments, the housing 221 includes an optical waveguide 224 defining at least a portion of the optical path 222. The optical waveguide can include one or more of an optical fiber and/or more generally a dielectric waveguide, e.g., a rectangular waveguide, a planar waveguide, an elliptical waveguide, and so on. According to the illustrative example, the optical waveguide 224 is optically coupled between the optical port 223 and the reflector 226 and adapted to guide one of an optical test signal 227, an optical response signal 228 or both the optical test signal 227 and the optical response signal 228 along at least a corresponding portion of the optical path 222.

According to the illustrative example, the housing 221 includes an optical filter 225 positioned along the optical path 222. The optical filter 225 is configured to filter a downstream signal, e.g., the optical test signal 227. In particular, the optical filter 225 is configured to filter the optical test signal 227 according to a distinct optical wavelength profile associated with the optical signature responder 220. For example, the optical filter 225 can be configured to pass a first optical wavelength component and to reject a second optical wavelength component. The first optical wavelength component can correspond to the first distinct optical wavelength profile associated with the optical signature responder 220, while the second optical wavelength component can correspond to other distinct optical wavelength profiles associated with other optical signature responders 214 (FIG. 2A) as may be deployed in an optical fiber distribution system 200.

According to the illustrative example, the optical filter allows the first optical wavelength component of the downstream optical test signal 227 to pass through the filter toward the reflector 226. The reflector 226 may include a broadband reflector that reflects incident optical signals without particular regard to wavelength. The reflector 226, having received the once filtered optical test signal 227, reflects the filtered optical test signal 227 and directs it along the optical path 222, back towards the optical filter 225. In at least some embodiments, the optical filter 225 can be a bidirectional device configured to filter an optical signal applied in either direction along the optical path 222 according to the filter characteristics. Namely, the optical filter 225 can be configured to pass the first optical wavelength component of the downstream optical test signal, while rejecting other wavelength components and to also pass the first optical wavelength component of a reflection of the first filtered optical test signal 227 returned to the optical filter 225 via a reflective surface of the reflector 226. The optical filter 225 passes an optical response signal 228 including the filtered first optical wavelength component corresponding to the first distinct optical wavelength profile associated with the optical signature responder 220.

In at least some embodiments, the optical filter 225 includes a thin film filter. The thin film filter can be aligned to provide a preferred filter response along the optical path 222. It is envisioned that the optical filter 225 can include one or more of a bandpass filter, a dichroic filter, a long-pass filter, a short-pass filter, a notch filter, an edge filter, fiber Bragg gratings and any combination thereof. In at least some embodiments, the optical filter 225 includes more than one filtering stage. The filtering stages can be similar and/or different, e.g., with each filter stage designed to transmit specific wavelengths of light while blocking others, depending on their application. In at least some embodiments, the optical filter 225 can include an absorptive filter having one or more coatings, e.g., made from organic and/or inorganic materials. The coating materials enable the filter to absorb undesirable wavelengths and transmit desirable wavelengths. Alternatively, or in addition, the optical filter 225 can include a dichroic filter, sometimes referred to as a thin-film filter and/or an interference filter. Dichroic filters can include one or more coatings configured to reflect undesirable wavelengths and transmit desirable wavelengths. In at least some embodiments, the optical filter 225 may include one or more grating filter configuration, such as a fiber Bragg grating-based optical fiber and/or an arrayed waveguide grating (AWG) filters. In general, the optical filter 225 may include any available filter type alone or in any combination, including combinations of the same type of filter.

The optical response signal 228, which comprises the reflected optical signal including the first wavelength component without the second wavelength component, is directed toward the optical fiber 229 via the optical port 223 e.g., directing the optical response signal 228 in an upstream direction towards the headend at the CO 202 (FIG. 2A). This optical response signal 228 is indicative of an interconnection of the device to a fiber plant, as described in the claims.

It is worth noting here that in at least some embodiments, the distinct optical wavelength profiles include a single wavelength and/or a relatively narrow wavelength band that can be approximated by a single wavelength or color. Accordingly, an optical signature responder 220 may be identified according to a distinct wavelength or color. It is envisioned that in at least some embodiments, the number of distinct wavelengths or colors may include up to some maximum number M of wavelengths or colors, e.g., up to 80 colors. It is understood that adjacent wavelengths or colors may be separated according to some minimum distinguishable value, such the optical detector 209b is able to distinguish wavelengths or colors in the optical response signal 228. It is understood further that in at least some embodiments, the upstream optical response signal 228 can be combined with other upstream optical response signals from other optical signature responders 214 (FIG. 1), e.g., by traversing the optical signal splitter 203 in an opposite direction to that described in relation to the downstream optical test signal.

To the extent that a number of optical signature responders 214 exceeds a maximum number of available wavelengths or colors, other techniques may be applied to extend the techniques described herein. For example, in at least some embodiments, one or more polarization filters may be deployed at any convenient location int eh optical fiber distribution system, e.g., at or within the optical signature responders 214. To the extent that the optical test source 209a and/or the optical detector 209b can distinguish different polarizations, the available wavelengths or colors may be extended, e.g., doubled. Accordingly, the optical detector 209b may be configured to distinguish two optical signature responders 214 using the same wavelength or color according to the polarization, with a requirement that such duplication of wavelengths or colors is permitted according to different polarizations.

Alternatively, or in addition, it is envisioned that optical response signals may be distinguished according to amplitude levels. For example, amplitudes of an optical response signal may be adjusted by one or more of an attenuation and/or an amplification, such that different optical signature responders 214 may utilize the same wavelength or color, subject to a respective amplitude range.

In at least some embodiments, different optical signature responders 214 may utilize the same wavelength or color, subject to a respective delay value. For example, optical signature responders 214 may be deployed such that any two using the same color are separated according to some distance threshold along the optical fiber distribution system. Accordingly, the optical detector 209b may be configured to measure and/or otherwise distinguish distinct optical wavelength profiles within an upstream optical response signal according to a delay value, e.g., measured with respect to a corresponding optical test signal. In such configurations, the optical detector 209b may utilize different time values and/or delay values or windows within which to monitor and/or otherwise expect different responses utilizing the same wavelength or color. At least one technique can utilize an optical time domain reflectometer (OTDR) to distinguish time and/or delay values.

Still other configurations can utilize combinations of wavelengths and/or colors. For example, at least some of the optical signature responders 214 deployed in the optical fiber distribution system may include an optical filter 225 and/or combination of more than one optical filter, such that the distinct optical wavelength profile includes at least two wavelengths or colors. Alternatively, or in addition, more than one single wavelength or color optical signature responders 214 configured with different respective wavelengths or colors may be deployed at a common location, e.g., at different optical ports 211 of the same fiber serving terminal 210. It may be advantageous to combine such color combinations with time delay.

FIG. 2C is a block diagram illustrating another example, non-limiting embodiment of an optical signature responder 230 functioning within the optical fiber distribution system 200 of FIG. 2A and the communications system 100 of FIG. 1 in accordance with various aspects described herein. The example optical signature responder 230 includes an optical port 232, e.g., an optical fiber connector configured to receive a downstream optical test signal including a first distinct optical wavelength component and a second distinct optical wavelength component. The example optical signature responder 230 further includes a housing 231 in communication with the optical port 232 and adapted to receive the downstream optical test signal and to direct it along an optical path towards an interior region 231a of the housing 231.

According to the illustrative example, the housing 231 includes a reflector 235 positioned along the optical path and adapted to reflect at least a portion of the downstream optical test signal to obtain a reflected optical signal. Without limitation, the reflector 235 can include any of the example reflective structures disclosed herein and/or otherwise generally known.

In at least some embodiments, the housing 231 includes an optical waveguide 233 defining at least a portion of the optical path. The optical waveguide 233 can include any of the example optical waveguides disclosed herein and/or otherwise generally known. According to the illustrative example, the optical waveguide 233 is optically coupled between the optical port 232 and the reflector 235 and adapted to guide one of the downstream optical test signal, an optical responses signal or both the downstream optical test signal and the optical response signal along at least a corresponding portion of the optical path.

According to the illustrative example, the housing 221 includes an optical filter 234 positioned along the optical path. The optical filter 234 is configured to filter the downstream optical test signal according to a distinct optical wavelength profile λ₁ associated with the optical signature responder 230. For example, the optical filter 234 can be configured to pass a first optical wavelength component and to reject a second optical wavelength component. The first optical wavelength component can correspond to the first distinct optical wavelength profile associated with the optical signature responder 230, while the second optical wavelength component can correspond to other distinct optical wavelength profiles associated with other optical signature responders 214 (FIG. 2A) as may be deployed in an optical fiber distribution system 200.

Further according to the illustrative embodiment, the housing 231 includes at least one lens 236 positioned along the optical path. For example, the lens 236 may be positioned between the optical waveguide 233 and the optical filter 234. The lens 236 may be configured to focus and/or disperse at least a portion of one of the downstream optical test signal and/or the upstream response signal as may be advantageous to enhance performance of the optical signature responder 230. In at least some embodiments, the lens 236 may be configured to expand the downstream optical test signal prior to traversal of the optical filter 234 and/or reflection by the reflector 235. Alternatively, or in addition, the lens 236 may be configured to focus the upstream optical response signal subsequent to reflection by the reflector 235 and/or traversal of the optical filter 234.

Although the optical filter 234 is shown as being disposed between the lens 236 and the reflector 235, it is understood that the lens 236 may be positioned elsewhere along the optical path, e.g., between the optical filter 234 and the reflector 235. Likewise, although the lens 236 is shown as abutting the optical filter 234 and the optical filter 234 is shown as abutting the reflector 235, it is understood that there may be at least some separation along the optical path between one or more of the lens 236, the optical filter 234 and/or the reflector 235.

FIG. 2D is a block diagram illustrating another example, non-limiting embodiment of an optical signature responder 240 functioning within the optical fiber distribution system 200 of FIG. 2A and the communications system 100 of FIG. 1 in accordance with various aspects described herein. The example optical signature responder 240 includes an optical port 242, e.g., an optical fiber connector configured to receive a downstream optical test signal including a first distinct optical wavelength component and a second distinct optical wavelength component. The example optical signature responder 240 further includes a housing 241 in communication with the optical port 242 and adapted to receive the downstream optical test signal and to direct it along an optical path towards an interior region 241a of the housing 241.

According to the illustrative example, the housing 241 includes at least one reflector 245 positioned along the optical path and adapted to reflect at least a portion of the downstream optical test signal to obtain a reflected optical signal. Without limitation, the reflector 245 can include any of the example reflective structures disclosed herein and/or otherwise generally known.

In at least some embodiments, the housing 241 includes first, second and third optical waveguide segments 243a, 243b, 243c, generally 243, defining at least a portion of the optical path. The optical waveguide segments 243 can include any of the example optical waveguides disclosed herein and/or otherwise generally known. According to the illustrative example, the housing 241 further includes an optical signal splitter 246. The first optical waveguide segment 243a is optically coupled between an input of the optical signal splitter 246 and the optical port 242. The second optical waveguide segment 243b is coupled between a first output of the optical signal splitter 246 and a first optical filter 244a. The third optical waveguide segment 243c is coupled between a second output of the optical signal splitter 246 and a second optical filter 244b. Each of the first and second optical filters 244a, 244b, generally 244, is optically coupled between the respective second and third optical waveguide segments 243b, 243c and the reflector 245. The reflector 235 is adapted to reflect a first filtered, first division of the downstream optical test signal back towards the first output of the optical signal splitter 246. Likewise, the reflector 235 is adapted to reflect a second filtered, second division of the downstream optical test signal back towards the second output of the optical signal splitter 246. The optical signal splitter 246, operating in a reverse direction, combines the first and second filtered, reflected divisions of the downstream optical test signal, resulting in a combined optical response signal.

It is envisioned that the first optical filter 244a may be configured to filter the first division of the downstream optical test signal according to a first distinct optical wavelength profile λ₁ associated with the optical signature responder 230. Likewise, the second optical filter 244b may be configured to filter the second division of the downstream optical test signal according to a second distinct optical wavelength profile λ₂ also associated with the optical signature responder 230. According to the combination or summing of the individual filtered reflections, the resulting upstream optical response signal may include a combination of the first and second distinct optical wavelength profiles λ₁, λ₂. The combination of optical wavelength components, i.e., λ₁+λ₂ can correspond to the first distinct optical wavelength profile associated with the optical signature responder 240, while the second optical wavelength component can correspond to other distinct optical wavelength profiles associated with other optical signature responders 214 (FIG. 2A) as may be deployed in an optical fiber distribution system 200.

FIG. 2E is a block diagram illustrating yet another example, non-limiting embodiment of an optical signature responder 250 functioning within the optical fiber distribution system 200 of FIG. 2A and the communications system 100 of FIG. 1 in accordance with various aspects described herein. The example optical signature responder 250 includes an optical port 252, e.g., an optical fiber connector configured to receive a downstream optical test signal including a first distinct optical wavelength component and a second distinct optical wavelength component. The example optical signature responder 250 further includes a housing 251 in communication with the optical port 252 and adapted to receive the downstream optical test signal and to direct it along an optical path towards an interior region 251a of the housing 251.

According to the illustrative example, the housing 251 includes a reflector array, e.g., a first reflector 255a and a second reflector 255b, positioned along the optical path and adapted to reflect at least a portion of the downstream optical test signal to obtain a reflected optical signal. Without limitation, the reflectors 255a, 255b, generally 255, can include any of the example reflective structures disclosed herein and/or otherwise generally known.

In at least some embodiments, the housing 251 includes first, second and third optical waveguide segments 253a, 253b, 253c, generally 253, defining at least a portion of the optical path. The optical waveguide segments 253 can include any of the example optical waveguides disclosed herein and/or otherwise generally known. According to the illustrative example, the housing 251 further includes an optical signal router 256. The first optical waveguide segment 253a is optically coupled between a first port of the optical signal router 256 and the optical port 252. The second optical waveguide segment 253b is coupled between a second port of the optical signal router 256 and an optical filter 254. The third optical waveguide segment 243c is coupled between a third port of the optical signal router 256 and the second reflector 255b.

The optical filter 254 is optically coupled between the second optical waveguide segments 253b, and the first reflector 255a. The first reflector 255a is adapted to reflect a first filtered, first division of the downstream optical test signal back towards the second reflector 255b, which, in turn, is adapted to reflect the reflected first filtered first division of the downstream optical test signal toward the second terminal of the optical signal router 256. The optical signal router 256 includes three terminals: a first terminal receiving a downstream optical test signal; a second terminal passing the downstream optical test signal towards the second optical waveguide segment 253b; and a third terminal receiving the filtered, twice reflected downstream optical test signal and redirecting it towards the first waveguide segment 253a via the first port. In at least some embodiments, the optical signal router 256 can be configured as an optical circulator device, e.g., an optical fiber circulator device. For example, when configured according to an optical circulator device, the optical signal router 256 can take the input signal 253a and only allows the signal to go out one port of the 256, while the reflection 253c can only come back in one port directionally.

It is envisioned that the optical filter 254 may be configured to filter the first division of the downstream optical test signal according to a first distinct optical wavelength profile λ₁ associated with the optical signature responder 250, while rejecting a second optical wavelength component corresponding to other distinct optical wavelength profiles associated with other optical signature responders 214 (FIG. 2A) as may be deployed in an optical fiber distribution system 200.

FIG. 2F is a block diagram illustrating another example, non-limiting embodiment of an optical fiber distribution system 260 functioning within the communications system 100 of FIG. 1 in accordance with various aspects described herein. The optical fiber distribution system 260 includes an optical source 261 coupled to an optical fiber feeder cable 262. The optical fiber feeder cable 262 includes a first branch 264a located at a first distance d₁ from the optical source 261. The first branch 264a extends for a first branch distance l₁ from the optical fiber feeder cable 262. The optical fiber feeder cable 262 includes a second branch 264b at a second distance d₂ from the optical source 261. The second branch 264b extends for a second branch distance l₂ from the optical fiber feeder cable 262. The optical fiber feeder cable 262 includes third and fourth branches 264c, 264d at a third and fourth distances d₃, d₄ from the optical source 261. The third and fourth branches 264c, 264d extend for a third and fourth branch distances l₃, l₄ from the optical fiber feeder cable 262.

According to the illustrative example, the first branch 264a is coupled to a first optical signature responder 263a, which is located at a distance of d₁+l₁ from the optical source 261 and configured to operate according to a first distinct optical wavelength profile λ₁. Likewise, the second branch 264b is coupled to a second optical signature responder 263b, which is located at a distance of d₂+l₂ from the optical source 261 and configured to operate according to a second distinct optical wavelength profile λ₂. Similarly, the third and fourth branches 264c, 264d are coupled to a third and fourth optical signature responders 263c, 263d, which are respectively located at distances of d₃+l₃ and d₄+l₄ from the optical source 261 and configured to operate according to third and fourth distinct optical wavelength profiles λ₃, λ₄.

FIG. 2G is a graph 265 illustrating example optical test signals, obtained from a non-limiting embodiment of an optical signature responder functioning within the optical fiber distribution system 260 of FIG. 2F and the communications system 100 of FIG. 1 in accordance with various aspects described herein. An example spectral graph of an optical test signal 266 is illustrated according to a power vs. wavelength graph. The optical test signal 266 includes a first distinct optical wavelength profile 276a centered at or about a first wavelength λ₁ and extending to a first power level P_{TX}. The optical test signal 266 further includes a second distinct optical wavelength profile 267b centered at or about a second wavelength λ₂ and extending to a second power level P_{TX}. Similarly, the optical test signal 266 further includes third and fourth distinct optical wavelength profiles 267c, 267d centered at or about third and fourth wavelengths λ₃, λ₄ and extending to third and fourth power levels P_{TX}.

In at least some embodiments, the optical test signal 266 can be configured to include the first, second, third and fourth distinct optical wavelength profiles 267a, 267b, 267c, 267d, generally 267, based on an understanding that the optical fiber distribution system 260 (FIG. 2F) includes first, second, third and fourth optical signature responders 263a, 263b, 263c, 263d, generally 263, configured according to respective distinct optical wavelength profiles λ₁, λ₂, λ₃, λ₄. The optical test signal 266 can be injected into a proximal end of the optical fiber feeder cable 262 and directed to the optical signature responders 263, which, in turn, are configured to filter and reflect a corresponding one of the wavelength profiles, while rejecting other ones of the wavelength profiles. To the extent that the optical fiber distribution system 260 is not compromised, the upstream optical response signal includes all of the filtered and reflected distinct optical wavelength profiles λ₁, λ₂, λ₃, λ₄. However, to the extent any one or more of the optical paths between the optical source 261 and the optical signature responders 263 has been compromised, those affected ones of the optical signature responders 263 are unable to provide an upstream optical reply signal according to the respective distinct optical wavelength profiles.

According to the illustrative example, there is a break in the third branch 264c, such that the third optical signature responder 263c is unable to provide a corresponding upstream optical reply signal including the third distinct optical wavelength profile λ₃. An example spectral graph of an optical upstream response signal 268 is illustrated according to a power vs. wavelength graph. The optical upstream response signal 268 includes a first distinct optical wavelength profile 269a centered at or about the first wavelength λ₁ and extending to a first receive power level P_{RX}. The optical upstream response signal 268 further includes a second distinct optical wavelength profile 269b centered at or about a second wavelength λ₂ and extending to a second receive power level P_{RX}. Similarly, the optical upstream response signal 268 further includes a fourth distinct optical wavelength profile 269d centered at or about the fourth wavelengths λ₄ and extending to a fourth receive power levels P_{RX}. However, the optical upstream response signal 268 fails to include a third distinct optical wavelength profile 269c, understood to be centered at or about the third wavelengths λ₃. With an understanding that the optical fiber distribution system 260 (FIG. 2F) includes the third optical signature responder 263c, and that the third optical signature responder 263c is associated with the third distinct optical wavelength profile 269c, and when combined with a failure to monitor, measure, detect and/or otherwise observe a corresponding distinct optical wavelength profile 269c (shown in phantom), a fault detection controller 209c (FIG. 2A) can conclude and/or otherwise identify a compromise to operation of the optical fiber distribution system 260 at least with respect to the third branch 264c.

Although the received power levels are shown to be approximately equal at P_{RX}, it is understood that there will likely be at least some variation. It is understood further that a conclusion that any one of the expected distinct optical wavelength profiles 269 in the optical upstream response signal 268 is missing may be determined according to a received power level being below a predetermined threshold and/or reflect a signal difference above a predetermined attenuation threshold when compared to the corresponding distinct optical wavelength profile of the downstream optical test signal 266.

FIG. 2H is another graph 270 illustrating example optical test signals, obtained from a non-limiting embodiment of an optical signature responder functioning within the optical fiber distribution system 260 of FIG. 2F and the communications system 100 of FIG. 1 in accordance with various aspects described herein. An example distance (delay) graph of an optical response signal is illustrated according to a power vs. wavelength graph. The optical response signal includes a first distinct optical wavelength profile 271a corresponding to a first wavelength λ₁ measured according to a first delay corresponding to a first distance d₁+l₁. The first distinct optical wavelength profile 271a extends to some discernable power level. The optical test signal also includes second and fourth distinct optical wavelength profiles 271b, 271d corresponding to second and fourth wavelengths λ₂, λ₄ measured according to second and fourth delays corresponding to second and fourth distances d₂+l₂ and d₄+l₄. The second and fourth distinct optical wavelength profiles 271b, 271d also extend to some discernable power levels. The example distance (delay) graph of an optical response signal may be obtained using an OTDR system adapted to detect a continuity, e.g., a reflection as may be introduced by an optical signature responder 263, at a distance corresponding to a location of the optical signature responder 263.

Once again, continuing with the illustrative example, a break in the third branch 264c, such that the third optical signature responder 263c is unable to provide a corresponding upstream optical reply signal including the third distinct optical wavelength profile λ₃. As shown, the optical response signal fails to include a third distinct optical wavelength profile, understood to be centered at or about a third distance d₃+l₃. With an understanding that the optical fiber distribution system 260 (FIG. 2F) includes the third optical signature responder 263c, and that the third optical signature responder 263c is associated with the third distinct optical wavelength profile, and when combined with a failure to monitor, measure, detect and/or otherwise observe a corresponding distinct optical wavelength profile 271c (shown in phantom), a fault detection controller 209c (FIG. 2A) can conclude and/or otherwise identify a compromise to operation of the optical fiber distribution system 260 at least with respect to the third branch 264c.

FIG. 2I depicts an illustrative embodiment of an optical fiber terminal failure detection process 280 in accordance with various aspects described herein. According to the illustrative process 280, signature wavelength profiles are associated with fiber serving terminals at step 281. In this step, distinct optical wavelength profiles are associated with respective fiber serving terminals (FSTs) within the optical fiber distribution network. For example, as shown in FIG. 2A, the first optical signature responder 214a is associated with a first distinct optical wavelength profile, and the second optical signature responder 214b is associated with a second distinct optical wavelength profile.

According to the illustrative process 280, an optical test signal including signature wavelength profiles is generated at step 282. For example, an optical test signal is generated, which includes the distinct optical wavelength profiles associated with the optical signature responders. As illustrated in FIG. 2G, the optical test signal 266 includes multiple distinct optical wavelength profiles 267a, 267b, 267c, and 267d, each corresponding to different optical signature responders.

Further, according to the illustrative process 280, an optical test signal is injected into a head end of the fiber distribution network at step 283. For example, the generated optical test signal can be injected into the head end of the fiber distribution network, as depicted in FIG. 2A, where the optical test source 209a injects the optical test signal into an optical fiber feeder cable, e.g., optical fiber feeder cable 201, via an optical coupling device 219.

A reflected optical response signal is monitored, e.g., at a headend of a fiber distribution network at step 284. The reflected optical response signal can be monitored at the head end of the fiber distribution network, e.g., as shown in FIG. 2A, using optical detector 209b to monitor a reflected optical response signal, which includes the distinct optical wavelength profiles reflected by the optical signature responders.

At step 285, a determination is made as to whether any signature wavelength profile(s) are missing. For example, the monitored optical response signal can be analyzed to determine if any of the expected signature wavelength profiles are missing. As illustrated in FIG. 2G, the absence of the third distinct optical wavelength profile 269c in the optical upstream response signal 268 indicates a potential fault in the corresponding optical path.

To the extent it is determined at step 285 that no signature wavelength profiles are missing, the process 280 may return to injecting a subsequent optical test signal at step 283 and continuing with the process 280 as described above. However, to the extent it is determined at step 285 that any signature wavelength profiles are missing, the corresponding suspect fiber serving terminal(s) can be identified at step 286 based on the associated missing wavelength profiles. For example, the absence of the third distinct optical wavelength profile would indicate a fault associated with the third optical signature responder 263c, as shown in FIG. 2F.

In at least some embodiments, a corrective action can be optionally initiated at step 287 (shown in phantom) for the identified suspect fiber serving terminal(s). This may involve dispatching a technician to the location of the suspect terminal to investigate and resolve the issue. The corrective action ensures the integrity and reliability of the optical fiber distribution network.

In summary, FIG. 2I outlines a systematic process for detecting and addressing faults in an optical fiber distribution network by leveraging distinct optical wavelength profiles associated with fiber serving terminals. This process ensures efficient fault detection and resolution, thereby maintaining the network's performance and reliability.

While for purposes of simplicity of explanation, the respective optical fiber terminal failure detection process 280 is shown and described as a series of blocks in FIG. 2I, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

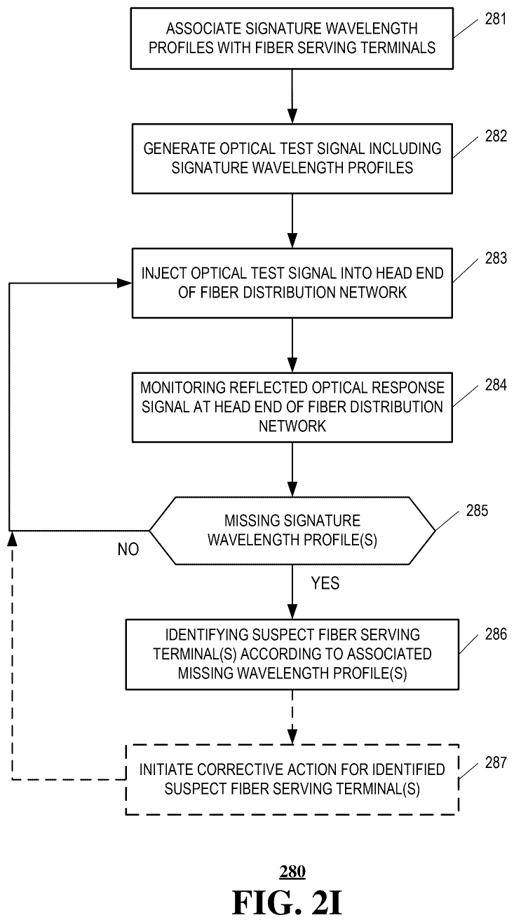

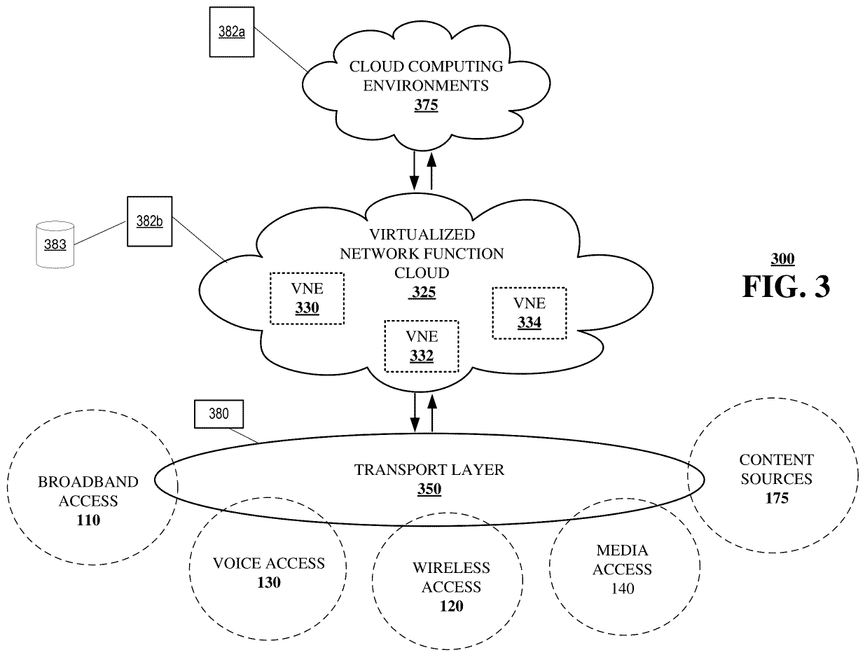

Referring now to FIG. 3, a block diagram is shown illustrating an example, non-limiting embodiment of a virtualized communications network 300 in accordance with various aspects described herein. In particular a virtualized communications network 300 is presented that can be used to implement some or all of the subsystems and functions of system 100, the subsystems and functions of devices and systems 200, 220, 230, 240, 250 and process 280 presented in FIGS. 1, 2A, 2B, 2C, 2D, 2E, 2I and 3. For example, virtualized communications network 300 can facilitate in whole or in part associating an optical signature with an optical signature responder deployed at a predetermined location and configured to reflect a signature spectral portion of an optical test signal corresponding to the optical signature, while rejecting other portions of the test signal. An absence of the signature spectral portion within a response signal indicates a fault condition associated with the responder and at the predetermined location.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communications network 300 employs virtual network elements (VNEs) 330, 332, 334, etc., that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. At other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc., to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc., can be instantiated and managed using an orchestration approach similar to those used in cloud compute services.

The cloud computing environments 375 can interface with the virtualized network function cloud 325 via APIs that expose functional capabilities of the VNEs 330, 332, 334, etc., to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

The example virtualized communications network 300 includes one or more optical signature responders 380 deployed in respective optical fiber distribution systems and configured to respectively filter a common downstream optical test signal according to a respective distinct optical wavelength profile and to return a filtered, upstream optical response signal. A fault detection system 382 is provided in communication with the optical signature responders 380, e.g., via the virtualized communications network 325 and/or the cloud computing environment 375. The fault detection system 382 can include an optical signal source configured to generate an optical test signal comprising a group of distinctive optical wavelength profiles. The fault detection system 382 can include an optical detector configured to detect and/or otherwise monitor an optical reply signal as may be returned by the optical signature responders 380. The fault detection system 382 may be configured to access a predetermined association of the optical signature responders 380 with their respective deployed locations, e.g., a record of the association as may be retained in a fault detection storage system 383. The fault detection system 382 may be configured to identify situations in which one or more of the distinctive optical wavelength profiles of the optical test signal fail to be observed in the optical response signal, and to further identify locations of any corresponding optical signature responders 380. The identified locations can be reported, e.g., according to an alarm and/or a status report, such that investigative and/or corrective action may be undertaken to remedy any deficiencies as may exist in the virtualized communications network 300.

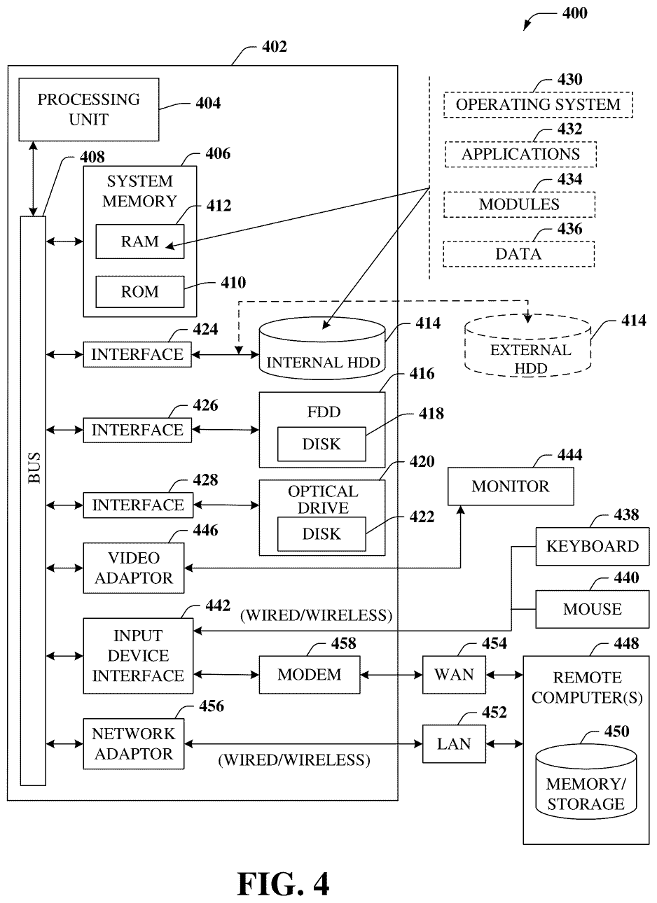

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part associating an optical signature with an optical signature responder deployed at a predetermined location and configured to reflect a signature spectral portion of an optical test signal corresponding to the optical signature, while rejecting other portions of the test signal. An absence of the signature spectral portion within a response signal indicates a fault condition associated with the responder and at the predetermined location.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communications media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communications network interface or adapter 456. The adapter 456 can facilitate wired or wireless communications to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communications network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communications network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to,” “coupled to,” and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
an optical port configured to receive an optical test signal comprising a first wavelength component and a second wavelength component; and
a housing in communications with the optical port, wherein the optical port is adapted to receive the optical test signal from an optical fiber and to direct the optical test signal along an optical path towards an interior region of the housing, wherein the interior region of the housing comprises:
a reflector positioned along the optical path and adapted to reflect at least a portion of the optical test signal to obtain a reflected optical signal;
an optical waveguide defining at least a portion of the optical path, wherein the optical waveguide is optically coupled between the optical port and the reflector; and
an optical filter positioned along the optical path and configured to pass the first wavelength component and to reject the second wavelength component, wherein an optical response signal comprises the reflected optical signal comprising the first wavelength component without the second wavelength component is directed toward the optical fiber via the optical port, the optical response signal indicative of an interconnection of the device to a fiber plant.

2. The device of claim 1, wherein the reflector comprises a mirror.

3. The device of claim 2, wherein the mirror comprises a first surface mirror.

4. The device of claim 1, wherein the reflector comprises a planar reflector.

5. The device of claim 1, wherein the optical waveguide comprises an optical fiber.

6. The device of claim 1, wherein the optical filter comprises a passband filter.

7. The device of claim 6, wherein the passband filter comprises a thin film filter, an arrayed waveguide grating or a combination thereof.

8. The device of claim 1, wherein the first wavelength component comprises a narrow bandwidth and the second wavelength component comprises a wide bandwidth.

9. The device of claim 1, wherein the housing comprises an environmentally sealed housing.

10. The device of claim 1, further comprising:
a lens positioned along the optical path, wherein the lens is adapted to redirect at least a portion of one of the optical test signal, the optical response signal, or both the optical test signal and the optical response signal.

11. The device of claim 1, wherein the optical filter is configured to filter both the optical test signal and the optical response signal.

12. A method, comprising:
associating, by a processing system including a processor, a first optical signature comprising a first distinct optical wavelength profile of a plurality of distinct optical wavelength profiles, with a first optical distribution terminal deployed at a first predetermined location of a plurality of optical distribution terminals deployed at a plurality of predetermined locations, wherein the first optical distribution terminal is optically coupled to a distal end of an optical fiber cable, wherein the first optical distribution terminal is configured to selectively reflect only the first distinct optical wavelength profile of the plurality of distinct optical wavelength profiles;
generating, by the processing system, an optical test signal comprising the plurality of distinct optical wavelength profiles;
injecting, by the processing system, the optical test signal into a proximal end of the optical fiber cable to obtain a transmitted optical test signal directed toward the plurality of optical distribution terminals;
measuring, by the processing system and at the proximal end of the optical fiber cable, an optical spectrum of an optical response signal to obtain a measurement result, wherein the optical spectrum of the optical response signal comprises the plurality of distinct optical wavelength profiles;
detecting, by the processing system, an absence of the first distinct optical wavelength profile within the measurement result; and
identifying, by the processing system and responsive to the absence of the first distinct optical wavelength profile, a fault condition associated with the first optical distribution terminal.

13. The method of claim 12, wherein the first distinct optical wavelength profile comprises a unique wavelength compared to other wavelengths of the plurality of distinct optical wavelength profiles.

14. The method of claim 12, wherein the measuring the optical spectrum of the optical response signal further comprises measuring an optical power level.

15. The method of claim 12, wherein the measuring the optical spectrum of the optical response signal further comprises measuring a time delay indicative of the first predetermined location of the first optical distribution terminal of the plurality of optical distribution terminals deployed at the plurality of predetermined locations.

16. The method of claim 12, further comprising:
identifying, by the processing system and responsive to the absence of the first distinct optical wavelength profile, a first fault condition associated with the first predetermined location.

17. The method of claim 16, further comprising:
initiating, by the processing system and responsive to the first fault condition, a corrective action at the first predetermined location.

18. A non-transitory machine-readable medium, comprising executable instructions that, when executed by a processing system including a processor, facilitate performance of operations, the operations comprising:
associating a first optical signature comprising a first distinct optical wavelength profile of a plurality of distinct optical wavelength profiles, with a first optical signature responder deployed at a first predetermined location of a plurality of optical signature responders deployed at a plurality of predetermined locations, wherein the first optical signature responder is optically coupled to a distal end of an optical fiber cable, wherein the first optical signature responder is configured to selectively reflect only the first distinct optical wavelength profile of the plurality of distinct optical wavelength profiles;
injecting an optical test signal comprising the plurality of distinct optical wavelength profiles into a proximal end of the optical fiber cable to obtain a transmitted optical test signal directed toward the plurality of optical signature responders;
monitoring, at the proximal end of the optical fiber cable, an optical spectrum of an optical response signal to obtain a monitored optical spectrum, wherein the monitored optical spectrum comprises the plurality of distinct optical wavelength profiles, and wherein the optical response signal comprises portions of the optical test signal reflected by the plurality of optical signature responders;
detecting an absence of the first distinct optical wavelength profile within the monitored optical spectrum; and
identifying, responsive to the absence of the first distinct optical wavelength profile, a fault condition associated with the first optical signature responder.

19. The non-transitory machine-readable medium of claim 18, wherein the first distinct optical wavelength profile comprises a unique wavelength compared to other wavelengths of the plurality of distinct optical wavelength profiles.

20. The non-transitory machine-readable medium of claim 18, wherein the operations further comprise:
identifying, by the processing system and responsive to the absence of the first distinct optical wavelength profile, a first fault condition associated with the first predetermined location.
